(19) United States
(12) Patent Application Publication
(10) Pub. No.: US 2025/0312985 A1
(43) Pub. Date: Oct. 9, 2025

(54) ROTARY TABLET PRESS

(71) Applicant: Fette Compacting GmbH, Schwarzenbek (DE)

(72) Inventors: Alexander Evers, Bargteheide (DE); Sven Kolbe, Buchen (DE); Stefan Ludemann, Hamburg (DE)

(73) Assignee: Fette Compacting GmbH, Schwarzenbek (DE)

(21) Appl. No.: 19/090,865

(22) Filed: Mar. 26, 2025

(30) Foreign Application Priority Data
Apr. 4, 2024 (DE) 10 2024 109 411.7

(51) Int. Cl. B30B 11/00; B30B 11/08

(52) U.S. Cl. CPC B30B 11/005; B30B 11/08

(57) ABSTRACT

A rotary tablet press includes a rotor that is structured to be rotated by a rotary drive in a pressing chamber of the rotary tablet press. The rotor includes an upper punch guide for upper pressing punches and a lower punch guide for lower pressing punches as well as a die plate arranged between the punch guides. The pressing punches cooperate with cavities defined in the die plate. A filling apparatus dispenses powder material into the cavities of the die plate. A pressure apparatus with an upper pressure unit and a lower pressure unit cooperates with the upper pressing punches and with the lower pressing punches during operation in order to press the powder material in the cavities of the die plate into tablets. A tablet sensor is positioned in the pressing chamber and structured to measure a content property of tablets produced in the rotary tablet press.

### CROSS-REFERENCE TO RELATED APPLICATION

This application claims the benefit and the priority under 35 U.S.C. § 119 of German Patent Application No. 10 2024 109 411.7, filed on Apr. 4, 2024, the entire contents of which are hereby incorporated by reference.

### TECHNOLOGICAL FIELD

The following disclosure is directed to embodiments of a rotary tablet press, comprising a rotor that can be rotated by means of a rotary drive in a pressing chamber of the rotary tablet press. The rotor has an upper punch guide for upper pressing punches and a lower punch guide for lower pressing punches as well as a die plate arranged between the punch guides, wherein the pressing punches cooperate with cavities of the die plate. The rotary tablet press further comprises a filling apparatus, by means of which powder material to be pressed is filled into the cavities of the die plate. The rotary tablet press further comprises a pressure apparatus having an upper pressure unit and a lower pressure unit, which cooperate with the upper pressing punches and with the lower pressing punches during operation in order to press the powder material in the cavities of the die plate into tablets. A tablet sensor is arranged in the pressing chamber and is configured to measure a content property of tablets produced in the rotary tablet press.

### BACKGROUND

In rotary tablet presses, a large number of upper and lower pressing punches are generally provided which are in each case assigned to one cavity of a die plate in pairs. During operation of the rotary tablet press, the upper and lower pressing punches rotate together with the die plate, wherein their axial movement is controlled by control cams and guided by upper and lower punch guides. During the course of the rotation, the die plate travels through various apparatuses of the rotary tablet press, namely a filling apparatus, in which powder material to be pressed is filled into the cavities of the die plate, and a pressure apparatus, in which the upper and lower pressing punches are pushed into the cavities by means of upper and lower pressure units, for example pressure rollers, in order to press the powder material into pellets, such as tablets. After the pressure apparatus, the upper pressing punches are guided upward out of the cavities and the pellets produced in the cavities are pushed by the lower pressing punches onto the upper side of the die plate. The pellets are then scraped off the die plate, for example by a scraper, into an outlet of the rotary tablet press, from where they are fed to further processing.

Tablet sensors are used in rotary tablet presses to measure the content properties of the tablets produced in the press, for example the proportion of an active pharmaceutical ingredient (API). A tablet sensor of this kind is known, for example, from EP 1 568 480 B1. In addition to one or more active pharmaceutical ingredients, tablets produced in rotary tablet presses usually comprise one or more excipients. The total weight of tablets produced in the tablet press is known and can also be measured. Based on the measured values of the tablet sensor relating, for example, to the API content in the tablet, it is possible to check whether the API content and the weight of the tablets are within specified parameters.

The tablet sensor described in EP 1 568 480 B1 is an NIR or LIF sensor that is arranged in the pressing chamber above the die plate in such a way that it records measured values of tablets produced in the tablet press after the upper punches have been moved out of the cavities. The tablet sensor is arranged stationarily above the die plate such that the tablets still inside the cavity of the die plate are moved through a measuring region of the tablet sensor as the rotor rotates.

In order to determine accurate measured values with such a tablet sensor, it is known to carry out a white balance of the tablet sensor. To do this, the tablet sensor is held outside the tablet press over a white or gray reference surface such that the measuring region detects the reference surface. On this basis, the tablet sensor is balanced against the reference surface. This enables reliable measured values to be recorded. However, there is a problem if, after the external balancing, parameter changes occur within the rotary tablet press due to influences during the tableting process. Fluctuations in luminous power also have an influence on the measured values of the tablet sensor. It is not possible to readjust the tablet sensor during the process.

Proceeding from the prior art explained above, the object of the invention is to provide a rotary tablet press of the type mentioned at the outset by means of which reliable measured values can be obtained at any time by means of a tablet sensor, even if the parameters change during the course of a tableting process.

### BRIEF SUMMARY OF THE INVENTION

With regard to a rotary tablet press of the type mentioned at the outset, the invention achieves the object in that an optical reference surface is also arranged in the pressing chamber, and in that a sensor drive is provided, by means of which the tablet sensor can be moved between a measuring position, in which a measuring region of the tablet sensor detects tablets produced in the rotary tablet press in order to measure the content property of the tablets, and a balancing position, in which the measuring region of the tablet sensor detects the reference surface, and in that a control apparatus is provided, to which measured values of the tablet sensor are applied and which is designed to balance the tablet sensor located in the balancing position against the reference surface.

The basic structure of a rotary tablet press, as is the subject matter of the present invention, was explained at the outset. According to some embodiments, an optical reference surface is positioned in the pressing chamber and a sensor drive is provided, by means of which the tablet sensor can be moved between a measuring position and a balancing position. In the measuring position, the tablet sensor uses its measuring region to detect tablets produced in the rotary tablet press to measure a content property of the tablets. For example, the tablets may still be inside the cavities of the die plate in the measuring position of the tablet sensor after the upper punches have moved out of the cavities. In the balancing position, however, the measuring region detects the reference surface. Both in the measuring position and in the balancing position, the tablet sensor generates measured values that are applied to a control apparatus. The control apparatus balances the tablet sensor against the reference surface based on the measured values of the tablet sensor in the balancing position. It is possible, for example, for the tablet sensor to be moved by the sensor drive at least in a radial direction towards the die plate and away from the die plate. The sensor drive and/or the tablet sensor may be arranged on a sensor table.

In some embodiments, the sensor drive may be configured to move the tablet sensor into different positions in the pressing chamber and can therefore be balanced even after being installed in the pressing chamber. A sensor head of the tablet sensor may, for example, be connected via an optical fiber to a radiation source and to the control apparatus. Balancing by carrying out a reference measurement of the reference surface using the tablet sensor in the balancing position can be carried out, for example, before and/or during and/or after a production process for producing tablets in the rotary tablet press. Balancing during a production process is particularly advantageous, since changes can be recognized and taken into account immediately. For example, the balancing can be carried out cyclically during production. Before production, the correct references and SSTs can be recorded and the uncalibrated internal standard can be compared or else set in relation to the calibrated 99% standard. During a production process, a dark current and an internal (white) reference can be determined at regular intervals, for example. The dark current serves as zeroing and the measurement of the internal (white) reference is converted with the determined relation into a calibrated external reference. This can then be used in the process. It is also possible to monitor that the reference measurements do not deviate too much, such that there is no soiling of the sensor and/or reference surface. In the event of soiling, the balancing is no longer correct and measures can be taken, such as stopping the rotary tablet press.

The invention makes it possible to take into account or else compensate for parameters that change, for example, in a production process or between production processes inside the pressing chamber of the rotary tablet press, in particular also after carrying out an external balancing of the tablet sensor. In this way, more reliable and robust sensor measured values are available. The balancing according to the invention takes place within the pressing chamber and can be carried out multiple times, for example during a production process and/or before and/or after a production process in the press. The sensor drive allows the balancing to take place automatically, in particular without the need for an operator to open the pressing chamber to gain corresponding access. This is particularly advantageous for pharmaceutical products processed in the rotary tablet press in order to minimize the burden on operators and/or to avoid costly protective measures, in particular in containment systems. Automatic balancing may, for example, take place at regular intervals and/or be triggered by an operator by entering data into the control apparatus. Tablet waste can be minimized.

In some embodiments, the reference surface may be a white or gray reference surface, wherein the control apparatus may be configured to perform a white balance or a gray balance of the tablet sensor against the reference surface.

In some embodiments, the sensor may be a spectroscopic sensor, in particular an NIR, LIF, or Raman sensor. Sensors of this kind are particularly suitable for measuring content properties, for example the API content of a tablet. Sensors of this kind comprise a transmitter for electromagnetic radiation, for example in the near infrared wavelength range, on the surface of the tablet and a receiver for receiving the electromagnetic radiation reflected back from the surface of the tablet. The radiation can be focused onto the surface of the tablet. By analyzing the spectrum of the reflected radiation, it is possible to determine the content of a specific ingredient in the tablet. As already explained, the content property may be a content of an active pharmaceutical ingredient (API) in the tablet. As also explained above, the tablet sensor may be located above the die plate in the measuring position, in particular in such a way that the tablets detected in the measuring region of the tablet sensor are still within a cavity of the die plate and are therefore defined in terms of their position.

According to a further embodiment, the sensor drive can move the tablet sensor in a horizontal plane. It is then advantageously not necessary to move the tablet sensor between the measuring position and the balancing position in the axial direction of the die plate. Laterally moving the tablet sensor in the horizontal plane is sufficient.

In some embodiments, the sensor drive may comprise at least one linear drive, for example two linear drives, for moving the tablet sensor in a linear movement and/or at least one rotary drive, for example two rotary drives, for moving the tablet sensor in a rotary movement. Using a suitably combined sensor drive, the tablet sensor can also be moved along a curved travel path, for example. As explained in more detail below, it is also possible to realize particular measuring paths over the reference surface and/or over a tablet. According to a particularly practical embodiment, the sensor drive may be an electric drive. However, other types of drive are also possible, such as a mechanical or pneumatic drive.

According to a further embodiment, it can be provided that the tablet sensor and/or the optical reference surface and/or the die plate and/or the sensor drive and/or a holder of the sensor drive further comprises a suction apparatus which is configured to suck product dust away from the measuring region of the tablet sensor and/or that the tablet sensor and/or the optical reference surface and/or the die plate further comprises a blow-out apparatus which is designed to blow out product dust from a measuring region of the tablet sensor. The suction apparatuses or else the blow-out apparatus, in particular comprising a compressed air nozzle, can be used to clean the reference surface in a targeted manner, for example during a cleaning run. In this way, any product dust that accumulates in the region of the measuring position and that could potentially distort the measurement can also be sucked away. In the same way, it is possible to clean a sensor measuring surface of the sensor and/or a tablet to be measured using the suction apparatus and/or using a blow-out apparatus comprising, for example, a compressed air nozzle. Cleaning can be carried out automatically, for example at regular intervals, by activating the suction apparatus and/or the blow-out apparatus by means of the control apparatus.

According to a further embodiment, the sensor drive may be configured to move the tablet sensor once or multiple times along a measuring path over the reference surface for balancing, wherein the tablet sensor records measured values multiple times during travel along the measuring path and transmits them to the control apparatus for the balancing. Of course, it is also possible that the sensor drive is designed to move the tablet sensor along a measuring path over a tablet to be measured, wherein the tablet sensor in turn records measured values multiple times during travel along the measuring path and transmits them to the control apparatus. It is also possible to adjust the measuring position such that measurements are taken outside the center of the tablet. In the aforementioned embodiment, the tablet sensor therefore moves to multiple balancing positions along the measuring path. The measuring path may extend along a straight line or have a curved shape. It is also possible for the reference surface to be traversed multiple times (shuttling), as well as for the reference surface to be traversed with an arc curve or another path curve. A measurement along such a measuring path makes it possible to detect and/or compensate for local inhomogeneities or soiling or shape deviations of the reference surface from the measured values for the balancing in order to avoid a corresponding distortion of the measured values. For example, the control apparatus may be designed to form a mean or median of measured values recorded along the measuring path for the balancing of the tablet sensor against the reference surface. The same applies to a measuring path over a tablet to be measured. In this way, an optimum measuring path of the tablet sensor can also be realized over the tablets to be measured.

According to a further embodiment, the control apparatus may be configured to compare measured values recorded in the balancing position for the balancing of the tablet sensor with measured values recorded as part of a previously performed balancing. The internal balancing according to the invention inside the pressing chamber is therefore compared with an external balancing carried out, for example, before the tablet sensor is mounted in the pressing chamber. The control apparatus may also be designed to detect and/or computationally compensate for fluctuations in radiant power, soiling of the tablet sensor and/or the reference surface, degradation of the tablet sensor, for example of a light source, and/or temperature changes as part of the balancing. Such changes that occur, for example, over time, for example in the tablet sensor, can be detected and compensated for by comparing them with an original external balancing.

If limit values for the detected and/or compensated variables are exceeded, the control apparatus can issue a warning signal and/or stop tablet production in the rotary tablet press. If, for example, it is determined during balancing that a degree of soiling of the tablet sensor exceeds a permissible limit value, it is possible to react accordingly before tablet waste is potentially produced. As already explained, the tablet sensor and/or the sensor drive and/or the reference surface may be arranged on a sensor table located in the pressing chamber.

The invention also relates to embodiments of a method for carrying out balancing of a tablet sensor with a rotary tablet press according to the invention.

### DESCRIPTION OF THE DRAWINGS

One exemplary embodiment of the invention is explained below in greater detail using figures.

FIG. 1 schematically illustrates an embodiment of a rotary tablet press according to the invention.

FIG. 2 schematically illustrates an enlarged perspective view of an embodiment of a tablet sensor used in the rotary tablet press in a first position.

FIG. 3 schematically illustrates the embodiment of FIG. 2 with the embodiment of the tablet sensor in a second position.

FIG. 4 schematically illustrates a perspective view of the embodiment of the tablet sensor from below.

If not otherwise specified, the same reference signs denote the same objects in the figures.

### DETAILED DESCRIPTION OF THE INVENTION

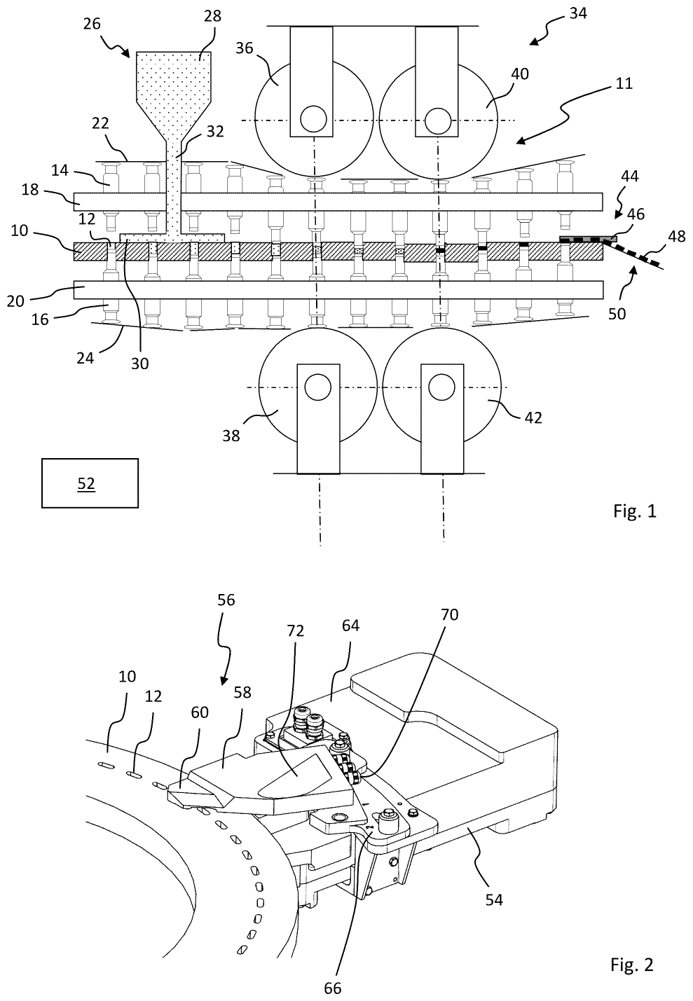

In an embodiment of the rotary tablet press shown in FIG. 1, powdered material is pressed into tablets. The rotary tablet press comprises a rotor driven in rotation by a rotary drive in a pressing chamber 11 and having a die plate 10, which has a plurality of cavities 12. The cavities 12 can be formed, for example, by bores in the die plate 10. The rotor further comprises multiple upper pressing punches 14 and lower pressing punches 16 which revolve synchronously with the die plate 10. The upper pressing punches 14 are axially guided in an upper punch guide 18 and the lower pressing punches 16 are axially guided in a lower punch guide 20. The axial movement of the upper pressing punches 14 and lower pressing punches 16 in the course of the rotation of the rotor is controlled by upper control cam elements 22 and lower control cam elements 24. The rotary tablet press further comprises a filling apparatus 26, which comprises a filling reservoir 28 and a filling chamber 30 which are connected via a filling tube 32. In this way, in the present example, powdered material arrives due to gravity from the filling reservoir 28 via the filling tube 32 into the filling chamber 30 and from there via a filling opening provided on the lower side of the filling chamber 30 into the cavities 12 of the die plate 10 again due to gravity.

The rotary tablet press further comprises a pressure apparatus 34. The pressure apparatus 34 comprises a pre-pressure apparatus having an upper pre-pressure roller 36 and a lower pre-pressure roller 38 as well as a main pressure apparatus having an upper pressure roller 40 and a lower pressure roller 42. Furthermore, the rotary tablet press comprises an ejector apparatus 44 and a scraper apparatus 46 having a scraper element which supplies the tablets 48 produced in the rotary tablet press to a discharge apparatus 50 for discharging from the rotary tablet press. The scraper apparatus 46 may, for example, comprise a preferably crescent-shaped scraper element which scrapes tablets 48 conveyed by the lower pressing punches 16 onto the upper side of the die plate 10 in the region of the ejector apparatus 44 off of the die plate 10 and supplies them to the discharge apparatus 50.

The rotary tablet press further comprises a control apparatus 52 configured to f control the operation of the rotary tablet press and configured to carry out balancing of a tablet sensor arranged in the pressing chamber 11 of the rotary tablet press, as explained in more detail below.

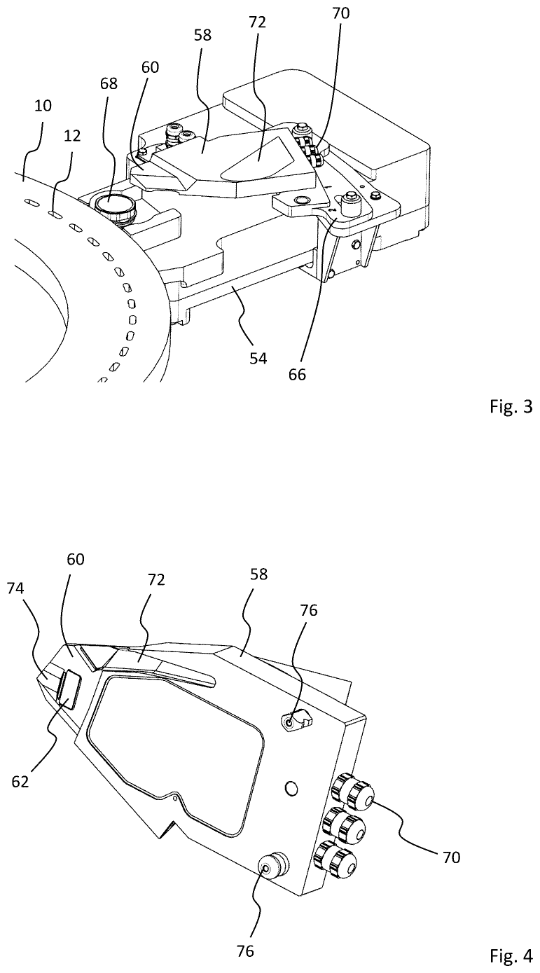

FIGS. 2 and 3 show a sensor table 54 which is arranged on the die plate 10 and on which a tablet sensor 56 is movably arranged. In some embodiments, the tablet sensor 56 comprises a sensor housing 58 and a sensor head 60. In the measuring position shown in FIG. 2, the sensor head 60 is located above the die plate 10 in such a way that a measuring region of the tablet sensor 56 detects tablets produced in the rotary tablet press and still located within the cavities 12 for a measurement of a content property, for example a content of an active pharmaceutical ingredient (API). A sensor surface 62 forming the measuring region can be seen in the view from below in FIG. 4. During operation of the rotary tablet press, the measured values recorded by the tablet sensor 56 in the measuring position are transmitted to the control apparatus 52, which uses them to check, for example, whether the measured content property is within specified parameters.

A sensor drive 64 is also arranged on the sensor table 54, by means of which sensor drive a holding portion 66 bearing the tablet sensor 56 can be moved radially in relation to the die plate 10 between the measuring position shown in FIG. 2 and a removal position shown in FIG. 3, from which the tablet sensor 56 can be removed from the pressing chamber 11. In some embodiments, the sensor drive 64 may be an electric sensor drive. In some embodiment, the sensor drive 64 may comprise at least one linear drive for linearly moving the tablet sensor 56 in the radial direction to the die plate 10. In some embodiments, the sensor drive 64 may also comprise a rotation drive by means of which the tablet sensor 56, in particular the sensor housing 58 thereof, can be rotated. The sensor drive 64 is controlled by the control apparatus 52.

Furthermore, a reference surface 68, which can be seen in FIG. 3 and is covered by the sensor housing 58 in FIG. 2, is located on the sensor table 54 and may be, for example, a white or gray reference surface 68. If the tablet sensor 56 is moved by means of the sensor drive 64 from the removal position shown in FIG. 3 into the measuring position shown in FIG. 2, the sensor surface 62 and thus the measuring region of the tablet sensor 56 traverses the reference surface 68 along a measuring path which, depending on the design and actuation of the sensor drive 64, may be a straight or a curved measuring path. As the tablet sensor 56 travels along the measuring path and thus through multiple balancing positions, the sensor head 60 uses the sensor surface 62 to record measured values of the reference surface 68, which are also transmitted to the control apparatus 52. Based on these measured values, the control apparatus 52 balances the tablet sensor against the reference surface 68. In particular, a white balance or gray balance, for example, can be performed automatically and within the pressing chamber 11 of the rotary tablet press in this way. If deviations from an external white or gray balance performed outside the pressing chamber 11 before mounting the tablet sensor 56 are detected, this can be taken into account by the control apparatus 52 when evaluating measured values of the tablet sensor 56 recorded in the measuring position, and in particular compensated for computationally.

In some embodiments, the tablet sensor 56 is a spectroscopic sensor, for example an NIR or LIF or Raman sensor. For this purpose, the sensor head 60 can be connected to an external radiation source for electromagnetic radiation, for example in the near-infrared wavelength range, for example via optical conductors connected to connections 70. The tablet sensor 56 can also be connected to the control apparatus 52 via the connections 70. Furthermore, a suction tube 72 is integrated into the sensor housing 58, which forms part of a suction apparatus. In this way, product dust that distorts the measurement results can be sucked away from the measuring region of the tablet sensor 56 and removed from the pressing chamber 11 of the rotary tablet press. Furthermore, a compressed air nozzle 74 is formed on the lower side of the sensor head 60 next to the sensor surface 62, which forms part of a blow-out apparatus and which can be connected to a corresponding compressed air supply. In this way, the region of the sensor surface 62 can also be freed from product dust or other dirt.

FIG. 4 in particular shows that the reference surface 68 is located in the plane of the upper side of the die plate 10. Thus, when the tablet sensor 56 is moved between the balancing positions and the measurement position, it is not necessary to move the tablet sensor 56 in the axial direction of the die plate 10. By means of mounting feet 76 provided on the lower side of the sensor housing 58, height adjustment is possible when mounting the tablet sensor 56 on the sensor table 54.

The balancing of the tablet sensor 56 explained above can be carried out automatically by the control apparatus 52, for example during each production process and/or before and/or after each production process for producing tablets in the rotary tablet press. It is not necessary to open the pressing chamber 11 for this. Any changes in parameters that influence the measurement results of the tablet sensor 56 during operation of the rotary tablet press can be reliably detected and taken into account. By recording measured values for the balancing along a measuring path over the reference surface 68, dirt and/or inhomogeneities, such as brightness or color deviations or unevenness, can be detected or else compensated for. The control apparatus 52 may, for example, create a mean or median of the measured values recorded along the measuring path. By means of the tablet sensor 56, it is also advantageously possible to record measured values along a measuring path over a tablet to be measured, i.e. to provide multiple measuring positions accordingly, for example controlled by the sensor drive 64 or, in the case of a stationary tablet sensor 56, by rotating the die plate 10. It is also possible to measure outside the center of the tablets in this way. This makes it possible to take into account deviations, for example, in the measured content property across the surface of the tablets. In this case, it is also possible for the control apparatus 52 to average the measured values recorded along the measuring path over a tablet in order to detect and/or compensate for distorting influences due to local changes in the content properties of a tablet.

### REFERENCE SIGNS

10 Die plate
12 Cavities
14 Upper pressing punches
16 Lower pressing punches
18 Upper punch guide
20 Lower punch guide
22 Upper control cam elements
24 Lower control cam elements
26 Filling apparatus
28 Filling reservoir
30 Filling chamber
32 Filling tube
34 Pressure apparatus
36 Upper pre-pressure roller
38 Lower pre-pressure roller
40 Upper pressure roller
42 Lower pressure roller
44 Ejector apparatus
46 Scraper apparatus
48 Tablets
50 Discharge apparatus
52 Control apparatus
54 Sensor table
56 Tablet sensor
58 Sensor housing
60 Sensor head
62 Sensor surface
64 Sensor drive
66 Holding portion
68 Reference surface
70 Connections
72 Suction pipe
74 Compressed air nozzle
76 Mounting feet

1. A rotary tablet press, comprising:
a rotor configured to be rotated by a rotary drive in a pressing chamber;
an upper punch guide for upper pressing punches;
a lower punch guide for lower pressing punches;
a die plate arranged between the upper and lower punch guides and defining a plurality of cavities, wherein the upper and lower press punches are configured to cooperate with plurality of cavities of the die plate;
a filling apparatus configured to dispense powder material into the plurality of cavities of the die plate;
a pressure apparatus comprising an upper pressure unit and a lower pressure unit that are configured to cooperate with the upper and lower pressing punches in order to press the powder material in the plurality of cavities of the die plate into tablets;
a tablet sensor comprising a measuring region and positioned in the pressing chamber and configured to measure a content property of tablets;
an optical reference surface positioned in the pressing chamber;
a sensor drive configured to move the tablet sensor between a measuring position and a balancing position, wherein when the tablet sensor is in the measuring position, the measuring region of the tablet sensor is configured detects the tablets in order to measure the content property of the tablets, and wherein when the tablet sensor is in the balancing position, the measuring region of the tablet sensor is configured to detect the reference surface; and
a control apparatus configured to receive measured values from the tablet sensor and configured to balance the tablet sensor against the reference surface when the tablet sensor is in the balancing position.

2. The rotary tablet press according to claim 1, wherein the reference surface comprises a white or gray color, and wherein the control apparatus is configured to perform a white balance or a gray balance of the tablet sensor against the reference surface.

3. The rotary tablet press according to claim 1, wherein the tablet sensor comprises a spectroscopic sensor.

4. The rotary press according to claim 3, wherein the spectroscopic sensor comprises one of an NIR, LIF or Raman sensor.

5. The rotary tablet press according to claim 1, wherein the tablet sensor is positioned above the die plate when the tablet sensor is in the measuring position.

6. The rotary tablet press according to claim 1, wherein the sensor drive is configured to move the tablet sensor along a horizontal plane.

7. The rotary tablet press according to claim 1, wherein the sensor drive comprises at least one of: (i) linear drive configured to drive a linear movement of the tablet sensor; and at least one rotary drive configured to drive a rotational movement of the tablet sensor.

8. The rotary tablet press according to claim 1, wherein the sensor drive comprises an electric drive.

9. The rotary tablet press according to claim 1, further comprising at least one of:
a suction apparatus configured to suck product dust away from the measuring region of the tablet sensor; and
a blow-out apparatus configured to blow out product dust from the measuring region of the tablet sensor.

10. The rotary tablet press according to claim 1, wherein the sensor drive is configured to move the tablet sensor along a measuring path over the reference surface for balancing, and wherein the tablet sensor is configured to record measured values multiple times during the movement along the measuring path and transmit the measured values to the control apparatus for the balancing.

11. The rotary tablet press according to claim 10, wherein the control apparatus is configured to determine a mean or median of the measured values recorded along the measuring path for the balancing of the tablet sensor against the reference surface.

12. The rotary tablet press according to claim 1, wherein the control apparatus is configured to compare measured values recorded in the balancing position for the balancing of the tablet sensor with measured values recorded as part of a previously performed balancing.

13. The rotary tablet press according to claim 1, wherein the control apparatus is configured to detect or compensate for:
fluctuations in at least one of: (i) radiant power; (ii) soiling of the tablet sensor and/or the reference surface; and
at least one of: (i) degradation the tablet sensor; and (ii) temperature changes as part of the balancing.

14. The rotary tablet press according to claim 13, wherein the control apparatus is configured to at least one of: (i) issue a warning signal; and (ii) stop tablet production in the rotary tablet press if it is determined that at least one of, limit values have been exceed, and compensated variables have been exceeded.
